(19) United States
(12) Patent Application Publication
(10) Pub. No.: US 2020/0399509 A1
(43) Pub. Date: Dec. 24, 2020

(54) SHOE INSOLE WITH AMBER

(71) Applicant: MARYNA DIACHENKO, Zhytomyr (UA)

(72) Inventor: MARYNA DIACHENKO, Zhytomyr (UA)

(21) Appl. No.: 16/654,830

(22) Filed: Oct. 16, 2019

(30) Foreign Application Priority Data
Jun. 21, 2019 (UA) U 2019 06959

(51) Int. Cl. C09J 11/08; C09J 163/00; A43B 13/42; A43B 17/00

(52) U.S. Cl. CPC C09J 11/08; A43B 17/003; A43B 13/42; C09J 163/00

(57) ABSTRACT

The utility model relates to the light industry and is intended for use as a prophylactic and hygienic means for human feet. A shoe insole with amber consists of a base and filler, wherein the base is made of an adhesive composition, in which the filler is located, and the filler is amber stones. The insole allows maintaining the prophylactic and hygienic effect during a long-term use thereof.

### CROSS REFERENCE TO RELATED APPLICATIONS

This application claims priority 35 U.S.C. § 119; to Ukraine Application No. u 2019 06959 filed on Jun. 21, 2019, the entire contents of which is hereby incorporated by reference.

### BACKGROUND

### 1. Field of the Invention

The utility model relates to the light industry and is intended for use as a prophylactic and hygienic means for human feet.

### 2. Background Art

There is known an acupressure insole according to the patent of Ukraine for utility model No. 56216, which acupressure insole is a base consisting of two interconnected layers of material, between which fillers are located. The filler is represented by rigid elements that have a geometric shape, preferably spherical or elliptical shape. It is suggested that kernels of fruit plants, preferably dogwood, cherry, cherry plum, are used as rigid elements. Natural filler, for example pyrium, flavouring and/or disinfecting agents are further used. The drawback of the suggested insole is that the massage elements move freely between the layers, thus leading to the accumulation thereof in certain places and to the reduction of the prophylactic and hygienic effects.

There is known an insole for the treatment and prophylactics of feet disease according to the patent of the Russian Federation No. 2308251, the insole being made of a base in the form of a deformable multilayer structure. The insole filler is a layer made of birch bark crushed to a size of not more than 15 mm. The drawback of the solution according to the patent of the Russian Federation No. 2308251 is that the birch bark is quickly deformed under the vertical load caused by the foot; fragments of the birch bark accumulate in certain places, thus reducing the prophylactic and hygienic effect of the article.

### SUMMARY

The object of the utility model is to create an insole, which, due to its properties, will allow maintaining the prophylactic and hygienic effect during a long-term use thereof.

Said object is achieved due to the fact that in the shoe insole with amber, which consists of a base and a filler, according to the claimed utility model, the base is made of an adhesive composition, in which the filler is located, and the filler is amber stones.

In one preferable embodiment of the utility model the adhesive composition will consist of the following elements:

Epoxy resins;

Self-leveling additives;

Polyamine;

Succinic acid.

It is desirable to select the size of the amber stones of no more than 4 mm or up to 7 mm.

Due to the fact that the base is made of the adhesive composition, and the amber stones are located in the base, it allows maintaining the prophylactic and hygienic effect of the use of the insole during the long-term use thereof, since the claimed insole is subject to much less destruction during vertical loads caused by the human foot. The selection of amber as a filler is caused by the fact that it has a therapeutic and antiseptic effect.

At the same time, if the adhesive composition consists of epoxy resin, self-leveling additives, polyamine, succinic acid, it will facilitate the manufacture of the base and increase the prophylactic and hygienic effect of the product due to the presence of succinic acid.

The base of the insole can be reinforced by gluing it onto the shoe leather-cardboard, thus reducing the friction between the base and the shoe sole and increasing the durability of the article.

The selection of the size of the amber stones is caused by the following. Based on the fact that an average thickness of the insole is 3 mm, when selecting the amber stones of no more than 4 mm, they are located inside the base and do not protrude. If the stones of up to 7 mm are selected when the thickness of the insole is 3 mm, they begin to protrude from the base. In this case, the stones are placed in such a way that they protrude on the side that faces the foot and the stones are preliminary treated making them smooth. This solution allows, in addition to the healing properties of amber, performing a foot massage.

### BRIEF DESCRIPTION OF THE DRAWINGS

The claimed utility model is explained by the following figures:

FIG. 1 shows an insole with amber stones with a size of no more than 4 mm;

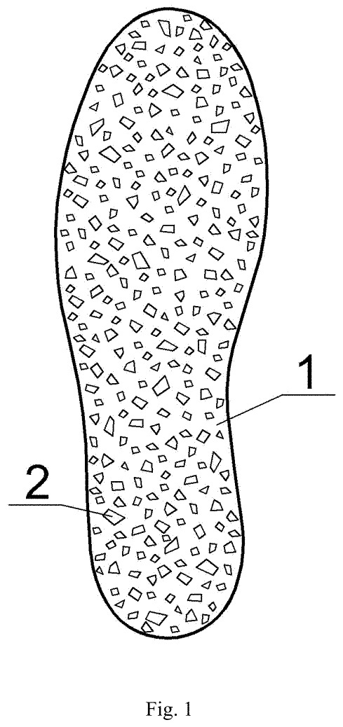

FIG. 2 shows an insole with amber stones with a size of up to 7 mm;

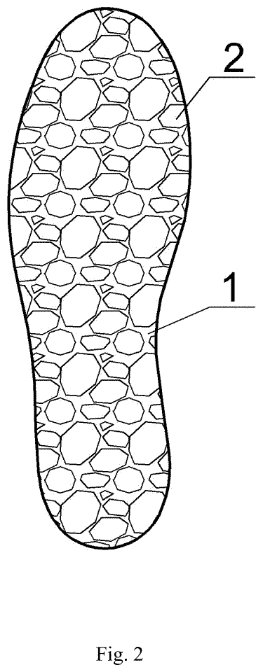

FIG. 3 shows an insole with amber stones glued to leather-cardboard.

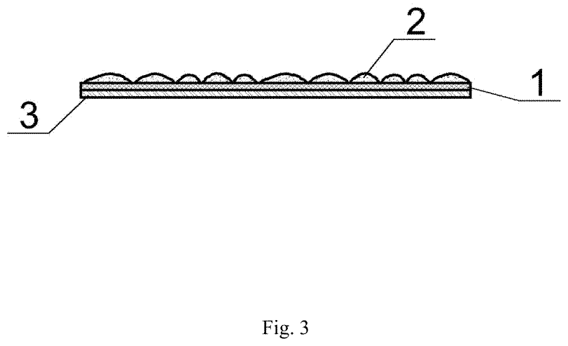

The insole consists of a base 1 made of an adhesive composition and a filler 2 of amber stones. The insole may have an additional layer of the shoe leather-cardboard 3.

### DETAILED DESCRIPTION

The insole is manufactured as follows. The amber stones of no more than 4 mm are mixed with the adhesive composition and poured into molds. When the composition is cured, the insoles are removed from the molds and moved for use. The insoles are placed in shoes and used in wear. The amber stones of up to 7 mm are placed in the adhesive composition, which is pre-poured into the molds. When the composition is cured, the insoles are removed from the molds and moved for use. Such an insole may be placed in the shoe or glued to the sole of slippers so that the protruding parts of the amber stones have contact with the human foot. If desired, the insoles can be glued to the leather-cardboard to increase the durability. Thus, the use of said insole allows obtaining the healing properties of amber (prophylactic and hygienic effect) during the long-term use thereof.

1. A shoe insole with amber consisting of a base and a filler, wherein the base is made of an adhesive composition, in which the filler is located, and the filler is amber stones.

2. The shoe insole with amber according to claim 1, wherein the adhesive composition consists of the following elements:
Epoxy resins;
Self-leveling additives;
Polyamine;
Succinic acid.

3. The shoe insole with amber according to claim 1, wherein the size of the amber stones is selected to be no more than 4 mm or up to 7 mm.
